(19) United States
(12) Patent Application Publication
(10) Pub. No.: US 2008/0132631 A1
(43) Pub. Date: Jun. 5, 2008

(54) HYDROLYSIS-RESISTANT THERMOPLASTIC POLYMER

(76) Inventors: KAVILIPALAYAM M. NATARAJAN, Holmdel, NJ (US); Stephen J. Hanley, Lebanon, NJ (US); Sean E. Gallagher, Andover, NJ (US)

Correspondence Address: BASF AKTIENGESELLSCHAFT, CARL-BOSCH STRASSE 38, 67056 LUDWIGSHAFEN, LUDWIGSHAFEN, 69056, omitted

(21) Appl. No.: 11/565,692

(22) Filed: Dec. 1, 2006

(51) Int. Cl. C08K 3/36; C08F 20/04; C08K 3/30; C08K 3/34

(52) U.S. Cl. 524/423; 524/451; 524/449; 524/447; 526/318.3

(57) ABSTRACT

A composition comprises a polyalkylene terephthalate and/or polyester thereof, a free triglyceride, a dendrimer, and optionally, an epoxy component. The composition is used to prepare a thermoplastic polymer. The composition and the thermoplastic polymer may be used to form an article having an improved hydrolysis resistance and an improved melt viscosity. The article may be useful for automotive, electrical, household, and industrial applications. A method of preparing the thermoplastic polymer is also disclosed.

### FIELD OF THE INVENTION

The present invention generally relates to a thermoplastic polymer having an improved melt viscosity. The invention also relates to an article having an improved resistance to hydrolysis and to a method of preparing the thermoplastic polymer.

### DESCRIPTION OF THE RELATED ART

Dendrimers are three dimensional highly branched and highly symmetric molecules having a treelike structure. Dendrimers are monodisperse or substantially monodisperse hyperbranched dendritic macromolecules that comprise a nucleus with two or more branching units extending therefrom. The branching units comprise branching layers and optionally one or more spacing layers and/or a layer of chain terminating molecules. Continued replication of the branching layers yields increased branch multiplicity, branch density, and an increased number of terminal functional groups compared to other molecules.

It is known to those skilled in the art of polymers to incorporate dendrimers into a thermoplastic polymer for rheology modification, i.e., for lowering a melt viscosity of the thermoplastic polymer. Melt viscosity is a measure of a resistance of a melt of the thermoplastic polymer to deform under shear stress, such as shear stress present within an extrusion process. An extrusion process or injection molding process is typically utilized to form an article from the thermoplastic polymer. A low melt viscosity makes the thermoplastic polymer easier to process, because the thermoplastic polymer flows faster, which is desirable when the articles must be formed into a complex shape. In addition, the low melt viscosity also decreases a cycle-time for making the articles because it takes less time for the thermoplastic polymer to fill in and conform to the complex shape of the article. Conversely, thermoplastic polymers having high melt viscosities are difficult to process because the thermoplastic polymer flows slower and resists conforming to the complex shape of the article when molded. As a result of having the high melt viscosity, the cycle-time also increases because it takes longer to press the thermoplastic polymer into the complex shape of the article.

Thermoplastic polymers compounded with dendrimers are disclosed, for example, in U.S. Pat. No. 6,225,404 to Sorenson et al. (the '404 patent). The '404 patent discloses a thermoplastic compound comprising a thermoplastic polymer and a dendrimer. The thermoplastic polymer and dendrimer both include a functional group where the two functional groups react to form the thermoplastic compound. The thermoplastic polymer may comprise polyalkylene terephthalate (PAT), more specifically polybutylene terephthalate (PBT). The dendrimer comprises a mono- or polymeric nucleus with branching units extending therefrom. Prior to reacting with the thermoplastic polymer, the dendrimer may be formed by reacting esters with an alcohol, both of which have functional groups for the reaction. The alcohol forms the nucleus and the esters form the branching units of the dendrimer. Further, the branching units may be chain terminated by a chain stopper such as a triglyceride. The thermoplastic compounds of the '404 patent are lower in melt viscosities than the thermoplastic polymers alone, due to the compounding with the dendrimers.

However, the thermoplastic compounds of the '404 patent have internal ester linkages that are susceptible to hydrolysis. Hydrolysis is a chemical reaction in which water molecules or its ions split chemical bonds and break a substance into smaller molecules. Articles formed from the thermoplastic compounds of the '404 patent that are exposed to humid conditions have a greater likelihood of undergoing hydrolysis. Articles that undergo hydrolysis tend to degrade, which is illustrated by worsened physical properties after hydrolysis than as before hydrolysis.

Articles based upon polyester compositions are also known to those skilled in the art of polymers. The polyester compositions of the related art typically include PAT and/or polyester thereof and various other additives, such as plasticizers, impact modifiers, lubricants, nucleating agents, epoxy components, and the like. More specifically, one related art composition includes a polyester, an impact modifier, and a compound having at least one functional group selected from the class consisting of anhydrides, epoxides, and hydroxyls. The epoxides may include epoxy formed from bisphenol A or epoxidized linseed oil. Further, the related art composition includes plasticizers and nucleating agents.

However, the related art compositions based upon the polyester compositions do not include the unique combination of the present invention to provide hydrolysis resistance. In addition, the related art compositions do not incorporate dendrimers and therefore have higher melt viscosities than the present invention. The higher melt viscosities of the related art compositions based upon the polyester compositions makes forming articles therefrom both difficult and time consuming.

The thermoplastic compound of the '404 patent and the related art compositions based upon the polyester compositions are characterized by one or more inadequacies. Specifically, the thermoplastic compounds of the '404 patent and the related art compositions are prone to hydrolysis, and therefore, the articles formed therefrom have physical properties that degrade unsatisfactorily when exposed to conditions favorable to hydrolysis. In addition, the related art compositions based upon the polyester compositions also have high melt viscosities. Accordingly, it would be advantageous to provide a composition that is hydrolysis resistant. In addition, it would also be advantageous to provide a thermoplastic polymer having an improved melt viscosity for forming an article having hydrolysis resistance.

### SUMMARY OF THE INVENTION AND ADVANTAGES

The present invention provides a composition useful in forming a thermoplastic polymer having an improved hydrolysis resistance and an improved melt viscosity. The composition comprises a polyalkylene terephthalate and/or polyester thereof, and a free triglyceride. The polyalkylene terephthalate and/or polyester thereof has terminal carboxyl groups and hydroxyl groups and internal ester linkages. The free triglyceride has at least one acid component and at least one epoxy group for reacting with the carboxyl groups. The composition also includes a dendrimer. The dendrimer has functional groups for reacting with the carboxyl groups.

The present invention further provides a thermoplastic polymer useful for making an article having an improved hydrolysis resistance and an improved melt viscosity. The thermoplastic polymer comprises the reaction product of the polyalkylene terephthalate and/or polyester thereof and the free triglyceride to form an intermediate compound. The intermediate compound has carboxyl groups. The thermoplastic polymer also includes the dendrimer. The dendrimer has functional groups reactive with the carboxyl groups of the intermediate compound for preparing the thermoplastic polymer.

The present invention yet further provides a method of preparing the thermoplastic polymer. The method comprises the steps of providing the polyalkylene terephthalate and/or polyester thereof and reacting the free triglyceride with at least one of the carboxyl groups of the polyalkylene terephthalate and/or polyester thereof to form the intermediate compound having carboxyl groups. The method also includes the step of reacting the dendrimer having functional groups with the carboxyl groups of the intermediate compound.

The present invention provides a unique combination of the polyalkylene terephthalate, the free triglyceride, and the dendrimer to form the composition and the thermoplastic polymer. The thermoplastic polymer has an improved hydrolysis resistance and an improved melt viscosity for making articles with the improved hydrolysis resistance. It is believed that the carboxyl groups of the polyalkylene terephthalate may be capped with hydrophobic groups of the free triglyceride. The capping of the carboxyl groups act as a buffer about the internal ester linkages of the polyalkylene terephthalate and reduces the likelihood of the thermoplastic polymer undergoing hydrolysis. Further, the free triglyceride may react in such a manner to provide ether linkages between the polyalkylene terephthalate and the free triglyceride. The ether linkages are hydrophobic which further reduces the likelihood of the thermoplastic polymer undergoing hydrolysis. It is believed that the polyalkylene terephthalate and the free triglyceride, when forming the intermediate compound, become entangled and thereby raise a melt viscosity of the intermediate compound. It is further believed that the dendrimer reacts in such a manner with the intermediate compound to untangle the intermediate compound. Untangling of the intermediate compound lowers the melt viscosity of the thermoplastic polymer. In addition, the present invention also provides a unique method for preparing the thermoplastic polymer.

### DETAILED DESCRIPTION OF THE INVENTION

A composition, a thermoplastic polymer, and a method of preparing the thermoplastic polymer are disclosed.

The thermoplastic polymer may be used to form an article. More specifically, the article formed therefrom has an improved resistance to hydrolysis. As understood by those skilled in the art, hydrolysis is a chemical reaction in which water molecules or its ions split chemical bonds and break a substance into smaller molecules. This may be particularly problematic for articles exposed to humid conditions or exposed to sources of water. Articles that undergo hydrolysis typically have reduced physical properties that shorten the lifespan of the articles and that may result in other problems arising during the use of the article. The improved resistance to hydrolysis of the present invention may substantially maintain the physical properties of the article even when exposed to such conditions.

In addition to the improved hydrolysis resistance, the thermoplastic polymer has an improved melt viscosity. An extrusion process or an injection molding process may be utilized to form the articles. However, it is to be appreciated that the present invention is not limited to any particular process for making the article. The improved melt viscosity of the present invention substantially maintains the physical properties of the article while improving overall processability for making the article from the thermoplastic polymer.

The present invention is particularly useful for, but is not limited to, automotive applications, electrical applications, household applications, and industrial applications. Illustrative examples of automotive applications include the following articles: housings and functional parts in electric drives, housings and mountings for various electrical and electronic components, windscreen/windshield wiper arms, door handles, headlamp structures, mirror systems, electrical connectors, sun-roof components, and housings for locking systems. Illustrative examples of electrical applications include the following articles: plug-in connectors, capacitor pots in coil formers, lamp parts, PC fans, and power supply components. Illustrative examples of household applications include the following articles: exterior surfaces for appliances, such as irons, deep fryers, coffee machines, and bristles for brushes, such as toothbrushes and hair brushes. Illustrative examples of industrial applications include the following articles: pump control units and shafts, meter housings, valves, and pumps, and camera and optical devices housings.

Both the composition and the thermoplastic polymer formed according to the present invention typically comprise reactive components and optionally, inert components. The reactive components react with one another; whereas the inert components are present to facilitate the processing of the composition and the thermoplastic polymer. The reactive components of the present invention are, if included, a polyalkylene terephthalate and/or polyester thereof, a free triglyceride, a dendrimer, an epoxy component, and fibers. The inert components of the present invention are, if included, a plasticizer, a lubricant, an antioxidant, a nucleating agent, a pigment, and other additives as known in the art. In connection with the present invention, inert is defined as tending not to affect the hydrolysis resistance and/or the melt viscosity of the composition and the thermoplastic polymer as described further below. It is to be appreciated that certain components, such as, but not limited to, the plasticizer or the lubricant, depending upon the specific composition, may react with various other components of the present invention. In addition, some of the reactive components may remain in an unreacted state within the composition or the thermoplastic polymer.

The composition comprises the polyalkylene terephthalate and/or polyester thereof, the free triglyceride, and optionally, the epoxy component. The polyalkylene terephthalate and/or polyester thereof has terminal carboxyl groups and hydroxyl groups and internal ester linkages. The free triglyceride has at least one acid component and at least one epoxy group for reacting with the carboxyl groups. By “free”, it is meant that the free triglyceride is initially a distinct component prior to reacting with the carboxyl groups. To contrast, a polymer may, for example, include a triglyceride as a chain stopper moiety which has reacted and is therefore no longer “free”. The epoxy component has at least one terminal epoxy group for reacting with the carboxyl groups. The composition also includes the dendrimer. The dendrimer has functional groups for reacting with the carboxyl groups. The polyalkylene terephthalate and/or polyester thereof will hereinafter be referred to as the polyalkylene terephthalate, for simplicity. The composition is useful for forming the thermoplastic polymer.

In one embodiment, the polyalkylene terephthalate is based on the reaction of aromatic dicarboxylic acids and an aliphatic or aromatic dihydroxy compound. Preferably, the aromatic dicarboxylic acids are terephthalic acid, 2,6-naphthalenedicarboxylic acid, isophthalic acid, and combinations thereof. It is to be appreciated by those skilled in the art that other aromatic dicarboxylic acids may be used for the present invention. The more preferred aromatic dicarboxylic acid is terephthalic acid. The aliphatic dihydroxy compounds are preferably diols with from 2 to 10 carbon atoms, in particular 1,2-ethanediol, 1,4-butanediol, 1,6-hexanediol, 1,4-hexanediol, 1,4-cyclohexanediol, 1,4-cyclohexanedimethylanol, neopentyl glycol, and combinations thereof. Those of ordinary skill in the art appreciate that other aliphatic dihydroxy compounds may be used for the present invention. The more preferred aliphatic dihydroxy compound is 1,4-butanediol.

In one embodiment, the polyalkylene terephthalate is selected from at least one of poly(butylene terephthalate) (PBT) and poly(ethylene terephthalate) (PET). It is to be appreciated by those skilled in the art that other polyalkylene terephthalates may be used for the present invention. Those of ordinary skill in the art appreciate that the polyalkylene terephthalate may also include a blend of polycarbonates with either the PBT or the PET. The more preferred polyalkylene terephthalate is PBT and/or polyesters thereof. Specific examples of suitable grades of PBT are commercially available from BASF Corporation of Wyandotte, Mich. The polyalkylene terephthalate may have a number average molecular weight of about 25,000 and a weight average molecular weight of about 50,000. It is to be appreciated that the polyalkylene terephthalate may have lower and/or higher number average and weight average molecular weights, respectively. A suitable PBT may be illustrated below by simplified Structure (I); where ‘n’ is equal to at least 1, and more typically is equal to about 100 or more.

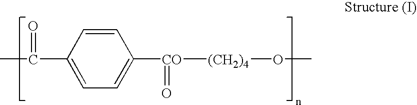

The viscosity number of the polyalkylene terephthalate is in the range from about 70 to about 220, and more preferably from about 80 to about 160, which may be measured in a 0.5% strength by weight solution in a mixture of phenol and o-dichlorobenzene (weight ratio of 1:1) at 25° C. The polyalkylene terephthalate has a content of carboxyl end groups (not shown above in Structure (I)) up to 100 meq/kg, more preferably up to 50 meq/kg, and most preferably up to 40 meq/kg of the polyalkylene terephthalate. The content of carboxyl end groups may be determined by titration methods as known in the art, e.g., potentiometry.

The polyalkylene terephthalate is present in an amount of from about 40 to about 90 parts by weight, more preferably of from about 45 to about 75 parts by weight, and most preferably of from about 50 to about 70 parts by weight, each based on 100 parts by weight of the composition.

The internal ester linkages of the polyalkylene terephthalate are prone to undergo hydrolysis. Further, the terminal carboxyl groups act as a catalyst for encouraging the polyalkylene terephthalate to undergo hydrolysis. Therefore, it would be advantageous to reduce the tendency of the polyalkylene terephthalate to undergo hydrolysis.

The free triglyceride has a number-average molecular weight of from about 400 to about 1000. The acid component of the free triglyceride preferably comprises 6 to 30 carbon atoms. More preferably, at least one of the acid components is epoxidized. Those of ordinary skill in the art appreciate that that the free triglyceride may be epoxidized in addition to or in place of the acid component. The reaction of the epoxy group with the carboxyl group of the polyalkylene terephthalate is believed to prevent the carboxyl group from acting as the catalyst for the hydrolysis. Further, this reaction results in ether linkages that are less prone to undergo hydrolysis. Since the epoxy group has reacted with the polyalkylene terephthalate, it is believed that the acid component acts as a buffer to the ester linkages in the polyalkylene terephthalate to further reduce the likelihood of the thermoplastic polymer undergoing hydrolysis. A suitable free triglyceride may be illustrated below by simplified Structure (II).

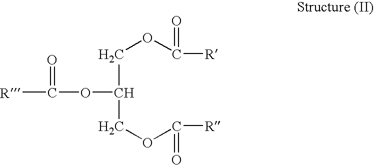

In Structure (II) above, two of or all of the R groups, i.e., R′, R″, and R′″, may be the same as each other. Alternatively, each of the R groups may be different from each other. The R groups each typically comprise an alkyl chain. However, each of the R groups may comprise other groups as known in the art.

Illustrative examples of the acid component include, but are not limited to, linseed oil, soybean oil, sunflower seed oil, safflower oil, hempseed oil, tung oil, oiticica oil, corn oil, sesame oil, cottonseed oil, castor oil, olive oil, peanut oil, rapeseed oil, coconut oil, babassu oil, and palm oil. It is to be appreciated by those skilled in the art that various combination and mixtures of the above acid components may also be utilized with the present invention. These acid components are derived from fatty acids that are hydrophobic, which are believed to increase the buffering effect and further stabilize the thermoplastic polymer. Most preferably, the free triglyceride is epoxidized linseed oil. A specific example of suitable epoxidized linseed oil is commercially available from Arkema Incorporated of Philadelphia, Pa. Those of ordinary skill in the art recognize that linseed oil is a glyceride of linolenic, linoleic, and oleic acids, which are each fatty acids.

The free triglyceride is present in an amount of from about 0.01 to about 10 parts by weight, more preferably of from about 0.01 to about 7.5 parts by weight, and most preferably of from about 0.05 to about 2.5 parts by weight, each based on 100 parts by weight of the composition. It is believed that the amount of the free triglyceride present in the composition helps to ensure that the carboxyl groups of the polyalkylene terephthalate do not catalyze the hydrolysis reaction.

In one embodiment, the epoxy component has at least one internal aromatic group and two terminal epoxy groups. In another embodiment, the epoxy component has two terminal epoxy groups and a number-average molecular weight of from about 100 to about 1000. If included, it is believed that the presence of the epoxy component further improves the hydrolysis resistance of the thermoplastic polymer by forming ether linkages similar to that of the free triglyceride described above. It is further believed that the epoxy component may also act as a chain extender if the polyalkylene terephthalate does undergo hydrolysis.

Illustrative examples of the epoxy component include, but are not limited to, bisphenol diglycidyl ethers, diglycidyl adducts of amines and amides, diglycidyl adducts of carboxylic acids, bis(3,4-epoxycyclohexylmethyl)adipate, and vinylcyclohexene di-epoxide. It is to be appreciated by those skilled in the art that various combination and mixtures of the above epoxy components may also be utilized with the present invention. The more preferred epoxy component is 2,2-bis[4-(2,3-epoxypropoxy)phenyl]propane, which is more commonly referred to as diglycidyl ether of Bisphenol A. A specific example of suitable 2,2-bis[4-(2,3-epoxypropoxy)phenyl]propane is commercially available from Huntsman of Salt Lake City, Utah.

The epoxy component may be made by methods as known to those skilled in the art. It is to be appreciated by those skilled in the art that the present invention is not limited to any particular method of making the epoxy component. The epoxy component is preferably a reaction product of bisphenol A with epichlorohydrin. If included, the epoxy component is present in an amount of from about 0.01 to about 10 parts by weight, more preferably of from about 0.01 to about 7.5 parts by weight, and most preferably of from about 0.05 to about 2.5 parts by weight, each based on 100 parts by weight of the composition. If included, it is believed that the amount of the epoxy component present in the composition in combination with the free triglyceride helps to ensure that the carboxyl groups of the polyalkylene terephthalate do not catalyze the hydrolysis reaction.

Without being bound or limited by any particular theory, it is believed that the composition increases in melt viscosity while forming. Specifically, it is believed that when the free triglyceride and the epoxy component, if included, react with the polyalkylene terephthalate, and optionally, with each other, the composition rises in melt viscosity due to tangle formation. It is believed that the tangles form due to physical and/or chemical characteristics of the composition. For example, the tangles occur when the polyalkylene terephthalate comprises a long polymer chain which entangles upon itself and/or the free triglyceride and the epoxy component, once reacted. Therefore, it would be advantageous to reduce the tendency of tangle formation to lower the melt viscosity of the thermoplastic polymer.

The dendrimer comprises a mono- or polymeric nucleus and a plurality of branching units extending from the nucleus. The branching units preferably comprise a polyester moiety, a polyether moiety, and combinations thereof. Those of ordinary skill in the art appreciate that the branching units may comprise other moieties. The branching units terminate with functional groups for reacting with the carboxyl groups of the polyalkylene terephthalate. The dendrimer may also react with other components within the composition, and alternatively or in addition to, some of the dendrimer may also remain in an unreacted state within the composition. The branching units may also have other functional groups not necessarily located at terminal positions such as internal functional groups located at internal positions between the branching units of the dendrimer. The term ‘branching unit’ may also be referred to as a dendron. The term ‘dendrimer’ may also be referred to as a hyperbranched dendritic macromolecule, a dendrimeric polymer, or a dendritic polymer as known to those skilled in the art.

One example of the dendrimer is illustrated by the below simplified structure (III).

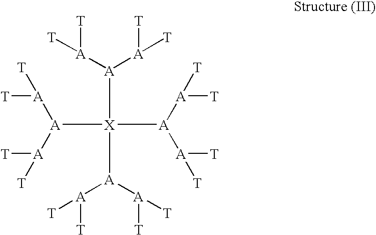

In Structure (III) above, ‘X’ is the nucleus having four branching units extending therefrom. ‘A’ is a moiety having three branches extending therefrom. ‘T’ is a terminating functional group. ‘T’ may be, for example, but not limited to, a hydroxyl group.

Another example of the dendrimer is illustrated by the below simplified structure (IV).

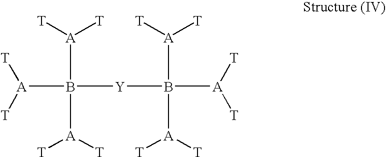

In Structure (IV) above, ‘Y’ is the nucleus having two branching units extending therefrom. ‘B’ is a moiety having four branches extending therefrom.

An example of the branching unit that may be incorporated into the dendrimer is illustrated by the below simplified structure (V).

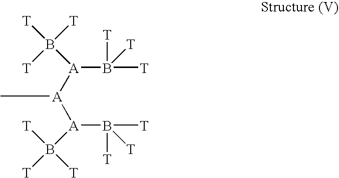

Structures (III), (IV), and (V), each have two generations. To clarify the two generations, Structure (V) above has a first generation comprising all of the ‘A’ moieties and a second generation comprising all of the ‘B’ moieties. The generation is defined as a layer within the branching unit, and therefore, within the dendrimer, as known to those skilled in the art.

The dendrimer includes one or more generations extending from the nucleus, with each of the generations comprising two or more of the branching units. The dendrimer has 1 to 100, more preferably has 1 to 20, and most preferably has 2 to 8 generations. Those having ordinary skill in the art appreciate that the dendrimer may have two, three, four, or more branching units extending from the nucleus, and may further have one, two, three, or more generations. It is also to be appreciated that the dendrimer may comprise any combination of branching units either shown or discussed herein.

The nucleus, prior to forming the dendrimer, includes a plurality of reactive groups selected from the group of, but not limited to, hydroxyl groups, epoxide groups, carboxyl groups, anhydride groups, and combinations thereof. The nucleus is preferably a mono- or polyfunctional alcohol or is an alkoxylate thereof, a mono- or polyfunctional epoxide, a carboxyfunctional compound, a mono- or polyhydroxyfunctional carboxylic acid or anhydrides, and combinations thereof.

Suitable mono- or polyfunctional alcohols and alkoxylates may be selected from the group of, but are not limited to, 5-ethyl-5-hydroxymethyl-1,3-dioxane, 5,5-dihydroxymethyl-1,3-dioxane, ethylene glycol, diethylene glycol, triethylene glycol, propylene glycol, dipropylene glycol, pentanediol, neopentyl glycol, 1,3-propanediol, 2-methyl-2-propyl-1,3-propanediol, 2-ethyl-2-butyl-1,3-propanediol, cyclohexanedimethanol, trimethylolpropane, trimethylolethane, glycerol, erythritol, anhydroennea-heptitol, ditrimethylolpropane, ditrimethylolethane, pentaerythritol, methylglucoside, dipentaerythritol, tripentaerythritol, glucose, sorbitol, ethoxylated trimethylolethane, propoxylated trimethylolethane, ethoxylated trimethylolpropane, propoxylated trimethylolpropane, ethoxylated pentaerythritol, propoxylated pentaerythritol, and combinations thereof. In one embodiment, the alkoxylate is a reaction product of a mono- or polyfunctional alcohol and an alkylene oxide. The alkylene oxide may be selected from the group of, but is not limited to, ethylene oxide, propylene oxide, butylene oxide, phenylethylene oxide, and combinations thereof.

Suitable mono- or polyfunctional epoxides may be selected from the group of, but are not limited to, glycidyl esters of monofunctional carboxylic acids having 1 to 24 carbon atoms; glycidyl ethers of monofunctional alcohols having 1 to 24 carbon atoms; glycidyl ethers of polyfunctional alcohols; mono- or polyglycidyl substituted isocyanurates; glycidyl ethers of condensation products between at least one phenol and at least one aldehyde or oligomers of such condensation products; glycidyl ethers of condensation products between at least one phenol and at least one ketone or oligomers of such condensation products; and glycidyl ethers of reaction products between at least one mono- or polyfunctional alcohol and at least one of ethylene, propylene, butylene and phenylethylene oxide; and combinations thereof.

Suitable carboxyfunctional compounds may be selected from the group of, but are not limited to, mono- or polyfunctional saturated carboxylic acids or anhydrides; mono- or polyfunctional unsaturated carboxylic acids or anhydrides; carboxyfunctional adducts of mono- or polyfunctional saturated carboxylic acids or anhydrides; carboxyfunctional adducts of mono- or polyfunctional unsaturated carboxylic acids or anhydrides; and combinations thereof.

Suitable mono- or polyhydroxyfunctional carboxylic acid or anhydrides may be selected from the group of, but are not limited to, 2,2-dimethylolpropionic acid, α,α-bis(hydroxymethyl)butyric acid, α,α,α-tris(hydroxymethyl)-acetic acid, α,α-bis(hydroxymethyl)valeric acid, α,α-bis(hydroxy)propionic acid, 3,5-dihydroxybenzoic acid, and α,β-dihydroxypropionic acid, and combinations thereof.

The branching unit may be pre-made and then added to the nucleus or alternatively, the branching unit may be built onto the nucleus. These two methods of making the dendrimer are known to those having ordinary skill in the art as convergent and divergent synthesis, respectively. The branching units are reacted with the reactive groups of the nucleus. It is to be appreciated by those skilled in the art that the present invention is not limited by any particular method of making the dendrimer. For example, the dendrimer may be a preexisting component or additive added to the composition.

In one embodiment, the branching units, prior to forming the dendrimer, comprise at least one mono- or polymeric branching chain extender having at least three functional groups of which at least one is a hydroxyl group and at least one is a carboxyl group or anhydride group, and optionally, at least one spacing generation comprising at least one spacing chain extender. The spacing chain extender may comprise a compound having two functional groups with one being a hydroxyl group and one being a carboxyl group, anhydride group, or an inner ether, such as a lactone of the compound. In one embodiment, the dendrimer is partially chain terminated by at least one mono- or polymeric chain stopper and is partially functionalized with at least one of the functional groups previously discussed.

The branching units may be made by condensing one or more hydroxyfunctional carboxylic acids at esterification temperatures as known to those skilled in the art. In another embodiment, the branching units are made by allowing mono- or polyfunctional carboxylic acids to form esterlinks with mono- or polyfunctional alcohols or epoxides. Those having ordinary skill in the art appreciate that the branching units may be made by other similar methods resulting in esterlinks, etherlinks or other chemical bonds. The raw materials used to make the branching units should be chosen to provide at least one terminal functional group to be reacted with the nucleus.

Illustrative examples of the branching chain extender include, but are not limited to, an aliphatic di- or polyhydroxyfunctional saturated or unsaturated monocarboxylic acid or anhydride; a cycloaliphatic di- or polyhydroxyfunctional saturated or unsaturated monocarboxylic acid or anhydride; an aromatic di- or polyhydroxyfunctional monocarboxylic acid or anhydride; an aliphatic monohydroxyfunctional saturated or unsaturated di- or polycarboxylic acid or anhydride; a cycloaliphatic monohydroxyfunctional saturated or unsaturated di- or polycarboxylic acid or anhydride; an aromatic monohydroxyfunctional di- or polycarboxylic acid or anhydride; an ester prepared from two or more of the hydroxyfunctional carboxylic acids or anhydrides; and combinations thereof.

The branching chain extender may comprise a hydroxyfunctional acid. The hydroxyfunctional acid is preferably selected from the group of, but is not limited to, 2,2-dimethylolpropionic acid, α,α-bis-(hydroxymethyl)butyric acid, α,α,α-tris(hydroxymethyl)acetic acid, α,α-bis-(hydroxymethyl)valeric acid, α,α-bis(hydroxy)propionic acid, 3,5-dihydroxybenzoic acid, α,β-dihydroxy-propionic acid, heptonic acid, citric acid, d- or l-tartaric acid, dihydroxymaloic acid, d-gluconic acid, and combinations thereof.

The spacing chain extender may be, but is not limited to, an aliphatic, cycloaliphatic or aromatic monohydroxyfunctional monocarboxylic acid or anhydride, or an inner ether of a monohydroxyfunctional monocarboxylic such as a lactone. In another embodiment, the spacing chain extender may be, but is not limited to, a hydroxyacetic acid, a hydroxyvaleric acid, a hydroxypropionic acid, a hydroxypivalic acid, a glycolide, a δ-valerolactone, a β-propiolactone, a \acute{ε}-caprolactone, and combinations thereof.

The branching chain extenders or the spacing chain extenders of the dendrimer may be reaction products between at least one di- or polycarboxylic acid or anhydride and at least one epoxide, more preferably, a glycidyl ester or ether comprising at least one alkenyl group, such as, but not limited to, glycidylacrylate, glycidylmethacrylate and allylglycidylether.

If employed, the chain termination of the dendrimer may be performed by means of a chain stopper having 1 to 24 carbon atoms. In one embodiment, the chain stopper may be selected from the group of, but is not limited to, an aliphatic or cycloaliphatic saturated or unsaturated monofunctional carboxylic acid or anhydride; a saturated or unsaturated fatty acid or anhydride; an aromatic monofunctional carboxylic acid or anhydride; a diisocyanate, an oligomer or an adduct thereof; a glycidyl ester of a monofunctional carboxylic acid or anhydride; a glycidyl ether of a monofunctional alcohol; an adduct of an aliphatic or cycloaliphatic saturated or unsaturated mono- or polyfunctional carboxylic acid or anhydride; an adduct of an aromatic mono- or polyfunctional carboxylic acid or anhydride; an epoxide of an unsaturated monocarboxylic acid or corresponding triglyceride, which acid has 3 to 24 carbon atoms; an aliphatic or cycloaliphatic saturated or unsaturated monofunctional alcohol; an aromatic monofunctional alcohol; an adduct of an aliphatic or cycloaliphatic saturated or unsaturated mono- or polyfunctional alcohol; an adduct of an aromatic mono- or polyfunctional alcohol; and combinations thereof.

Illustrative examples of suitable chain stoppers include, but are not limited to, formic acid, acetic acid, propionic acid, butanoic acid, hexanoic acid, acrylic acid, methacrylic acid, crotonic acid, lauric acid, linseed fatty acid, soybean fatty acid, tall oil fatty acid, dehydrated castor fatty acid, crotonic acid, capric acid, caprylic acid, acrylic acid, methacrylic acid, benzoic acid, behenic acid, montanoic acid, ρ-tert.butylbenzoic acid, abietic acid, sorbic acid, 1-chloro-2,3-epoxypropane, 1,4-dichloro-2,3-epoxybutane, epoxidised soybean fatty acid, 5-methyl-5-hydroxymethyl-1,3-dioxane, 5-ethyl-5-hydroxymethyl-1,3-dioxane, glycerol diallyl ether, trimethylolpropane diallyl ether maleate, trimethylolpropane diallyl ether, pentaerythritol triallyl ether, pentaerythritol triacrylate, pentaerythritol triethoxylate triacrylate, toluene-2,4-diisocyanate, toluene-2,6-diisocyanate, hexamethylene diisocyanate, phenyl isocyanate, isophorone diisocyanate, and combinations thereof.

The functional groups of the dendrimer are obtained through functionalization methods as known to those having ordinary skill in the art, such as, but not limited to, addition, oxidation, epoxidation and/or allylation, of the dendrimer and/or the chain termination, if employed. Functionalization of the dendrimer may be performed using an epihalohydrin, such as epichlorohydrin; an allylhalid, such as allylchloride or allylbromide; or an acrylonitrile yielding at least one cyano group. Functionalization of the dendrimer may also be performed by addition of at least one unsaturated anhydride to a nucleophilic end group, such as —O⁻ or —N₂⁻, or a Michael addition of at least one unsaturated anhydride, such as maleic anhydride, to an unsaturation within of the dendrimer and/or the chain termination, if employed. Oxidation may be performed using an oxidizing agent. The oxidizing agent may be selected from the group of, but is not limited to, peroxyformic acid, peroxyacetic acid, peroxybenzoic acid, m-chloroperoxybenzoic acid, trifluoroperoxyacetic acid, and combinations thereof.

The functional groups of the dendrimer may be selected from the group of, but are not limited to, hydroxyl groups, epoxide groups, carboxyl groups, anhydride groups, alkyl groups, and combinations thereof. The more preferred functional groups are hydroxyl groups. The dendrimer has 6 to 64, more preferably has 12 to 48, and most preferably has 16 to 32 hydroxyl groups. The functional groups react with the carboxyl groups of the polyalkylene terephthalate.

The dendrimer has a number-average molecular weight of from about 1500 to about 6500, more preferably of from about 1500 to about 3500, and most preferably of from about 1500 to about 2000. Specific examples of suitable grades of dendrimers are commercially available from Perstorp Incorporated of Florence, Mass. The dendrimer is present in an amount of from about 0.1 to about 10 parts by weight, more preferably of from about 0.1 to about 5 parts by weight, and most preferably of from about 0.1 to about 2 parts by weight, each based on 100 parts by weight of the composition. It is to be appreciated by those skilled in the art that various combination and mixtures of the dendrimer may also be utilized with the present invention. In other words, the present invention is not limited to only one molecule and/or limited to only type of the dendrimer. In one embodiment, the dendrimer is an amorphous solid. In another embodiment, the dendrimer is a viscous liquid. Those having ordinary skill in the art appreciate that the dendrimer may be in other physical states.

Without being bound or limited by any particular theory, it is believed that, due to physical and/or chemical characteristics of the dendrimer, in addition to reacting with the carboxyl groups of the polyalkylene terephthalate, the dendrimer acts as a physical untangling component to untangle tangles of the polyalkylene terephthalate. It is also believed that the dendrimer acts as the physical untangling component while reacted or while in an unreacted state within the composition. The improved melt viscosity of the present invention is believed to be caused by, at least in part, the dendrimer acting as the physical untangling component. It is to be appreciated by those skilled in the art that the improved melt viscosity may be due to a different aspect or aspects of the present invention.

As described above, the composition may further comprise at least one or more of the inert components. The inert components, while typically not reacting with the reactive components, may improve the processability of the composition and the thermoplastic polymer.

If included, the plasticizer preferably comprises an esterification product of a polyoxyalkylene glycol and an aliphatic carboxylic acid. Said another way, the polyoxyalkylene glycol is end-capped with the aliphatic carboxylic acid such that the plasticizer only includes one or two ester linkages. Preferably, the polyoxyalkylene glycol has 1 to 20 carbon atoms and the aliphatic carboxylic acid typically has 1 to 25 carbon atoms. It is believed that the plasticizer is useful for improving the melt viscosity of the thermoplastic polymer and for reducing hydrolysis of the thermoplastic polymer.

The polyoxyalkylene glycol may be selected from at least one of, but is not limited to, diethylene glycol, triethylene glycol, and polyethylene glycol having a number-average molecular weight greater than about 150. It is to be appreciated by those skilled in the art that various combination and mixtures of the above polyoxyalkylene glycols may also be utilized with the present invention. The polyoxyalkylene glycol has a plurality of internal ether linkages that are hydrophobic and it is believed that the polyoxyalkylene glycol therefore acts as a buffer to prevent hydrolysis of the thermoplastic polymer. The more preferred polyoxyalkylene glycol is polyethylene glycol having a molecular weight of about 300.

The aliphatic carboxylic acid is preferably a saturated monocarboxylic acid having a straight or branched chain with 1 to 10 carbon atoms. The saturated monocarboxylic acid may be selected from at least one of, but is not limited to, acetic acid, propionic acid, butyric acid, valeric acid, caproic acid, caprylic acid, capric acid, 2-ethylhexanoic acid, 2-methylhexanoic acid, 3-methylhexanoic acid, 4-methylhexanoic acid, 5-methylhexanoic acid, isooctonoic acid, 2-methylpropionic acid, 2-methylbutanoic acid, 2-ethylbutyric acid, 2-methylpentanoic acid, 3-methylpentanoic acid, and 4-methylpentanoic acid. It is to be appreciated by those skilled in the art that various combination and mixtures of the above saturated monocarboxylic acids may also be utilized with the present invention. The preferred saturated monocarboxylic acid is 2-ethylhexanoic acid. Since 2-ethylhexanoic acid only has a single carboxylic acid group, the polyethylene glycol is end-capped with the 2-ethylhexanoic acid.

If included, the plasticizer is present in an amount of from about 0.01 to about 10 parts by weight, more preferably of from about 0.01 to about 7.5 parts by weight, and most preferably of from about 0.01 to about 5 parts by weight, each based on 100 parts by weight of the composition. The amount of the plasticizer should be chosen to ensure the processability of the composition and the thermoplastic polymer while also improving the hydrolysis resistance of the composition and the thermoplastic polymer.

The composition may further comprise the fibers selected from at least one of, but not limited to, glass fibers, polyamide fibers, cellulose fibers, and ceramic fibers. It is to be appreciated by those skilled in the art that various combination and mixtures of the above fibers may also be utilized with the present invention. The more preferred fibers have a surface-active agent comprising epoxy groups for reacting with the carboxyl groups of the polyalkylene terephthalate. The epoxy groups of the surface-active agents create ether linkages with the carboxyl groups and may also reduce the possibility of the fiber absorbing water to effectuate the hydrolysis reaction.

The fibers are present in an amount of from about 5 to about 60 parts by weight, more preferably from about 20 to about 40 parts by weight, and most preferably about 30 parts by weight, each based on 100 parts by weight of the composition. The reaction between the surface-active agent and the polyalkylene terephthalate or the intermediate compound may also ensure that the fiber has good adhesion thereby improving the physical properties of the article formed therefrom. The surface-active agent preferably comprises a polyurethane structure, and more preferably is a reaction product of bis(cyclohexylisocyanato)methane, 1,6-hexanediol and adipic acid polyester, and bisphenol glycidyl ether.

If included, the lubricant is preferably an ester or amide of saturated aliphatic carboxylic acids having from 10 to 40 carbon atoms and saturated aliphatic alcohols or amines having from 2 to 40 carbon atoms. It is believed that when the lubricant includes fatty acid chains that are highly hydrophobic, the lubricant further aids in the hydrolysis resistance of the composition and the thermoplastic polymer. The preferred lubricant is pentaerythritol tetrastearate. If included, the lubricant is present in an amount of from about 0.01 to about 5 parts by weight, preferably of from about 0.01 to about 3 parts by weight, and more preferably of from about 0.01 to about 2 parts by weight, each based on 100 parts by weight of the composition.

If included, the thermal antioxidant preferably has a sterically hindered phenolic group. Those skilled in the art appreciate that various thermal antioxidants are available to stabilize the composition and the thermoplastic polymer without discoloring and to prevent thermo-oxidative degradation. In one embodiment, the thermal antioxidant is selected from at least one of, but is not limited to, pentaerythritol tetrakis(3-(3,5-di-tert-butyl-4-hydroxyphenyl)propionate), tetrakis(methylene-3-(3′,5′-di-tert-butyl-4′-hydroxyphenyl)propionate)methane, octadecyl-3-(3′,5′-di-tert-butyl-4′-hydroxyphenyl)propionate, 1,3,5-trimethyl-2,4,6-tris(3,5-di-tert-butyl-4-hydroxybenzyl)benzene, and 4,4′-(2,2-diphenylpropyl)diphenylamine. It is to be appreciated by those skilled in the art that various combination and mixtures of the above thermal antioxidants may also be utilized with the present invention. The preferred thermal antioxidant is pentaerythritol tetrakis(3-(3,5-di-tert-butyl-4-hydroxyphenyl)propionate). If included, the thermal antioxidant is present in an amount of from about 0.01 to about 5 parts by weight, more preferably of from about 0.01 to about 3 parts by weight, and most preferably of from about 0.01 to about 1.5 parts by weight, each based on 100 parts by weight of the composition.

The composition may further include additional additives known to those having ordinary skill in the art, such as but not limited to, nucleating agents, pigments, flame-retardants, and combinations thereof. For example, the composition and the embodiments of the thermoplastic polymer may include a nucleating agent selected from at least one of, but not limited to, talc, kaolin, mica, calcium sulfate, and barium sulfate. It is to be appreciated by those skilled in the art that various combination and mixtures of the above nucleating agents may also be utilized with the present invention. If included, the nucleating agent is present in an amount of from about 0.01 to about 2 parts by weight, more preferably of from about 0.01 to about 1 part by weight, and most preferably of from about 0.01 to about 0.5 parts by weight, each based on 100 parts by weight of the composition. It is believed that the nucleating agent increases crystallization of the composition.

If included, the pigment may include inorganic or organic compounds and may impart a special effect and/or color to the article. The pigment may also be dispersed in a carrier matrix, such as a plastic resin, as understood by those of ordinary skill in the art. In one embodiment, the pigment is carbon black pigment. It is to be appreciated by those skilled in the art that the pigment may be any one of or combination of pigments known in the art. If included, the pigment is present in an amount of from about 0.05 to about 5 parts by weight, more preferably of from about 0.5 to about 3 parts by weight, and most preferably of from about 0.5 to about 1.5 parts by weight, each based on 100 parts by weight of the composition. The amount of the pigment includes the amount of the carrier matrix, if any. If the carrier matrix is employed, the pigment is present in an amount of from 10 to 50 parts by weight based on 100 parts by weight of the pigment and carrier matrix, combined.

The thermoplastic polymer has a melt flow length of from about 60 to about 80 cm at a temperature of about 260° C. and at a pressure of between about 500 to about 1500 psi according to a spiral flow test method for determining a melt viscosity of the thermoplastic polymer. Examples of suitable spiral flow test methods include, but are not limited to ASTM D1238 and ISO 1133.

One typical process of preparing the composition and the thermoplastic polymer includes dry blending the components followed by pelletizing to form pellets. It is to be appreciated by those skilled in the art that other processes may also be used. The pellets are extruded, but other methods would also suffice to form the pellets. The pellets of the thermoplastic polymer may then be heated and molded into the article. The article may be formed via extrusion processes or injection molding processes. It is to be appreciated by those skilled in the art that the present invention is not limited to one particular method of making the article.

The method of preparing the thermoplastic polymer will now be discussed. The method comprises the steps of providing the polyalkylene terephthalate and/or polyester thereof and reacting the free triglyceride with at least one of the carboxyl groups of the polyalkylene terephthalate and/or polyester thereof to form the intermediate compound having carboxyl groups. The method also includes the step of reacting the dendrimer having functional groups with the carboxyl groups of the intermediate compound. As like above, the polyalkylene terephthalate and/or polyester thereof will hereinafter be referred to as the polyalkylene terephthalate, for simplicity.

Without being bound or limited by any particular theory, it is believed that the dendrimer acts as the physical untangling component to untangle tangles of the polyalkylene terephthalate and/or the intermediate compound, which lowers the melt viscosity of the intermediate compound and therefore, lowers the melt viscosity of the thermoplastic polymer once formed.

The steps of reacting the free triglyceride and reacting the dendrimer having functional groups with the carboxyl groups of the intermediate compound are conducted at a temperature of between about 150° C. to about 350° C. It is to be appreciated by those skilled in the art that these steps may also be conducted at lower or higher temperatures. The method of the present invention may be conducted in an apparatus selected from the group of, but is not limited to, compounders, single-screw extruders, extruders, ring extruders, mixers, and reaction vessels. The preferred apparatus is a twin-screw extruder. Those of ordinary skill in the art appreciate that other apparatuses may be used.

In one embodiment, the method further comprises the step of reacting the epoxy component having at least one terminal epoxy group with the carboxyl groups of the intermediate compound. In other embodiments, the method further comprises the step of reacting the epoxy component having at least one terminal epoxy group with the carboxyl groups of the polyalkylene terephthalate either prior to or during the formation of the intermediate compound. If the step of reacting the epoxy component is followed during the formation of the intermediate compound, that the epoxy component may also react with the intermediate compound, while forming, in addition to reacting with the polyalkylene terephthalate.

In other embodiments, the method may further comprise the step of providing at least one of the plasticizer, the fibers, the lubricant, the thermal antioxidant, the nucleating agent, and the pigment. It is to be appreciated by those skilled in the art that any combination of the aforementioned steps may be followed in the present invention. In addition, as with the step of reacting the epoxy component, any one of or combination of the aforementioned steps may be followed prior to, during, or after the formation of the intermediate compound. It is also to be appreciated that the fibers, if comprising the surface-active agent, may react with the polyalkylene terephthalate and/or the intermediate compound while forming the thermoplastic polymer according to the method of the present invention.

The following examples, illustrating the compositions of the present invention, are intended to illustrate and not to limit the present invention.

### EXAMPLES

The compositions are made by combining a polyalkylene terephthalate, a free triglyceride, a dendrimer, and optionally, an epoxy component, fibers, a lubricant, a plasticizer, a thermal antioxidant, a nucleating agent, and combinations thereof, in an apparatus to form the thermoplastic polymers. The amount and type of each component used to form the compositions are indicated in Table 1 below with all values in percent by weight based on 100 parts by weight of the composition unless otherwise indicated.

TABLE 1

| Components | Control 1 | Sample 1 | Sample 2 | Sample 3 | Sample 4 | Control 2 | Sample 5 | Sample 6 |
|---|---|---|---|---|---|---|---|---|
| Polyaklylene Terephthalate 1 | 65.10 | 64.35 | 64.35 | 64.35 | 64.35 | — | — | — |
| Polyaklylene Terephthalate 2 | | | | | | 63.60 | 62.10 | 62.10 |
| Triglyceride | 3.00 | 3.00 | 3.00 | 3.00 | 3.00 | 3.00 | 3.00 | 3.00 |
| Epoxy Component | 1.00 | 1.00 | 1.00 | 1.00 | 1.00 | 1.00 | 1.00 | 1.00 |
| Fibers | 30.00 | 30.00 | 30.00 | 30.00 | 30.00 | 30.00 | 30.00 | 30.00 |
| Lubricant | 0.50 | 0.50 | 0.50 | 0.50 | 0.50 | 0.50 | 0.50 | 0.50 |
| Plasticizer | — | — | — | — | — | — | — | — |
| Thermal Antioxidant | 0.30 | 0.30 | 0.30 | 0.30 | 0.30 | 0.30 | 0.30 | 0.30 |
| Nucleating Agent | 0.10 | 0.10 | 0.10 | 0.10 | 0.10 | 0.10 | 0.10 | 0.10 |
| Dendrimer 1 | — | 0.75 | — | — | — | — | 1.5 | — |
| Dendrimer 2 | — | — | 0.75 | — | — | — | — | 1.5 |
| Dendrimer 3 | — | — | — | 0.75 | — | — | — | — |
| Dendrimer 4 | — | — | — | — | 0.75 | — | — | — |

Polyalkylene Terephthalate 1 is PBT, commercially available as Ultradur ® B2550 from BASF Corporation.
Polyalkylene Terephthalate 2 is PBT, commercially available as Ultradur ® B4300 from BASF Corporation.
Triglyceride is an epoxidized linseed oil, commercially available as Vikoflex ® 7190 from Arkema Incorporated.
Epoxy Component is 2,2-bis[4-(2,3-epoxypropoxy)phenyl]propane, commercially available as Araldite ® from Huntsman.
Fibers are glass fibers having a surface-active agent comprising epoxy groups, commercially available from Asahi Glass Company.
Lubricant is pentaerythritol tetrastearate, commercially available as Loxiol VPG 861 from Cognis Corporation.
Thermal Antioxidant is pentaerythritol tetrakis (3-(3,5-di-tert-butyl-4-hydroxyphenyl) propionate), commercially available as Irganox ® from Ciba.
Nucleating Agent is talc, commercially available as Talc IT.
Dendrimer 1 is a dendrimer having an average of 16 hydroxyl functional groups per dendrimer molecule, commercially available as Boltorn ® from Perstorp Incorporated.
Dendrimer 2 is a dendrimer having an average of 32 hydroxyl functional groups per dendrimer molecule, commercially available as Boltorn ® from Perstorp Incorporated.
Dendrimer 3 is a dendrimer having an average of 6.4 hydroxyl functional groups per dendrimer molecule, commercially available as Boltorn ® from Perstorp Incorporated.
Dendrimer 4 is a dendrimer having an average of 3 alkyl functional groups per dendrimer, commercially available from Perstorp Incorporated.

The above compositions underwent a compounding operation as understood by those skilled in the art. The compounding operation dry blends the components together and then compounds the components in a twin-screw extruder at a temperature of about 250° C. and at about 250 revolutions per minute. The twin-screw extruder extrudes the thermoplastic polymer that is then cooled, preferably in a water bath, and then the thermoplastic polymer is pelletized. The pelletized thermoplastic polymer is then dried for about 4 hours at about 110° C.

The pelletized thermoplastic polymer is then molded into an article for testing. The article may have various shapes depending upon the desired test. For example, the pelletized thermoplastic polymer may be molded into tensile bars to test the tensile properties or may be molded into flexural bars to test the flexural properties.

The following tests were conducted on the samples and the physical properties were determined: viscosity number in accordance with ISO 1628 tensile strength in accordance with ISO 527, elongation in accordance with ISO 527, flexural strength and modulus in accordance with ISO 178, charpy impact in accordance with ISO 179, and spiral flow in accordance with ISO 1133.

TABLE 2

| | Control 1 | Sample 1 | Sample 2 | Sample 3 | Sample 4 | Control 2 | Sample 5 | Sample 6 |
|---|---|---|---|---|---|---|---|---|
| Properties | | | | | | | | |
| Tensile Strength, MPa | 135 | 135 | 125 | 124 | 125 | 112 | 116 | 113 |
| Elongation, % | 3 | 3 | 3 | 3.2 | 3.1 | 4.0 | 3.6 | 3.5 |
| Flexural Strength, MPa | 210 | 200 | 187 | 185 | 190 | 164 | 169 | 168 |
| Flexural Modulus, MPa | 7800 | 7550 | 7300 | 7100 | 7300 | 5870 | 5930 | 5970 |
| Charpy Notched, kJ/m² | 11.0 | 11.8 | 11.0 | 12.0 | 12.4 | 7.2 | 7.0 | 6.7 |
| Charpy Impact, kJ/m² | 73 | 74.6 | 67 | 68 | 70 | 62 | 44 | 47 |
| Spiral flow, cms @ | | | | | | | | |
| 500 psi | 27.0 | 42.0 | 39.0 | 36.0 | 36.0 | 30.0 | 42.5 | 44.5 |
| 1000 psi | 42.0 | 61.0 | 58.0 | 53.0 | 53.0 | 44.3 | 64.5 | 60.8 |
| 1500 psi | 54.0 | 76.0 | 71.0 | 67.0 | 66.0 | 56.0 | 79.2 | 72.0 |
| Viscosity Number | — | 13 | — | — | — | 117 | 110 | 111 |

Referring to the properties in Table 2 above, Samples 1 through 4 had longer spiral flow lengths, in centimeters, at various pressures, in psi, compared to Control 1, which indicates that the dendrimers improved a melt flow viscosity of the thermoplastic polymer. In addition, Samples 5 and 6 also had longer spiral flow lengths compared to Control 2.

The following tests were conducted on the article after molding and after the sample had been conditioned to determine the resistance to hydrolysis. The articles were exposed to a temperature of 110° C. and 100% relative humidity for ten days to condition the articles. The articles were removed from these conditions and the physical properties were tested again. The differences between the properties were converted to a percent retention for each property. Sample 1 had a conditioned tensile strength of 116 MPa, which is about 86% retention, a conditioned elongation of 2.4%, which is 80% retention, and a conditioned charpy impact of 45 kj/m², which is about 60% retention.

Obviously, many modifications and variations of the present invention are possible in light of the above teachings. The invention may be practiced otherwise than as specifically described within the scope of the appended claims.

What is claimed is:

1. A composition comprising:
a polyalkylene terephthalate and/or polyester thereof having terminal carboxyl groups and hydroxyl groups and internal ester linkages;
a free triglyceride having at least one acid component and at least one epoxy group for reacting with said carboxyl groups; and
a dendrimer having functional groups for reacting with said carboxyl groups.

2. A composition as set forth in claim 1 wherein said dendrimer comprises:
a mono- or polymeric nucleus; and
a plurality of branching units extending from said nucleus;
wherein said branching units terminate with said functional groups for reacting with said carboxyl groups.

3. A composition as set forth in claim 2 wherein each of said branching units comprise a polyester moiety, a polyether moiety, and combinations thereof.

4. A composition as set forth in claim 3 wherein said functional groups are hydroxyl groups and said dendrimer has 6 to 64 hydroxyl groups.

5. A composition as set forth in claim 3 wherein said dendrimer has a number-average molecular weight of from about 1500 to about 6500.

6. A composition as set forth in claim 1 wherein said free triglyceride is epoxidized linseed oil.

7. A composition as set forth in claim 1 further comprising an epoxy component having at least one terminal epoxy group for reacting with said carboxyl groups of said polyalkylene terephthalate and/or polyester thereof.

8. A composition as set forth in claim 7 wherein said epoxy component has at least one internal aromatic group and two terminal epoxy groups.

9. A composition as set forth in claim 1 further comprising a plasticizer comprising an esterification product of a polyoxyalkylene glycol and an aliphatic carboxylic acid.

10. A composition as set forth in claim 1 further comprising fibers selected from at least one of glass fibers, polyamide fibers, cellulose fibers, and ceramic fibers.

11. A composition as set forth in claim 10 wherein said fibers have a surface-active agent comprising epoxy groups for reacting with said carboxyl groups of said polyalkylene terephthalate and/or polyester thereof.

12. A composition as set forth in claim 1 further comprising a lubricant being an ester or amide of saturated aliphatic carboxylic acids having from 10 to 40 carbon atoms and saturated aliphatic alcohols or amines having from 2 to 40 carbon atoms.

13. A composition as set forth in claim 12 wherein said lubricant is pentaerythritol tetrastearate.

14. A composition as set forth in claim 1 further comprising a thermal antioxidant having a sterically hindered phenolic group.

15. A composition as set forth in claim 1 further comprising a nucleating agent selected from at least one of talc, kaolin, mica, calcium sulfate, and barium sulfate.

16. A thermoplastic polymer comprising the reaction product of:
a polyalkylene terephthalate and/or polyester thereof having terminal carboxyl groups and hydroxyl groups and internal ester linkages;
a free triglyceride having at least one acid component and at least one epoxy group reactive with said carboxyl groups of said polyalkylene terephthalate and/or polyester thereof to form an intermediate compound having carboxyl groups; and
a dendrimer having functional groups reactive with said carboxyl groups of said intermediate compound for preparing said thermoplastic polymer.

17. A thermoplastic polymer as set forth in claim 16 wherein said dendrimer comprises:
a mono- or polymeric nucleus; and
a plurality of branching units extending from said nucleus;
wherein said branching units terminate with said functional groups reactive with said carboxyl groups of said intermediate compound for preparing said thermoplastic polymer.

18. A thermoplastic polymer as set forth in claim 17 wherein each of said branching units comprise a polyester moiety, a polyether moiety, and combinations thereof.

19. A thermoplastic polymer as set forth in claim 18 wherein said functional groups are hydroxyl groups and said dendrimer has 6 to 64 hydroxyl groups.

20. A thermoplastic polymer as set forth in claim 18 wherein said dendrimer has a number-average molecular weight of from about 1500 to about 6500.

21. A thermoplastic polymer as set forth in claim 16 wherein said free triglyceride is epoxidized linseed oil.

22. A thermoplastic polymer as set forth in claim 16 comprising the further reaction product of said intermediate compound, said dendrimer, and an epoxy component having at least one terminal epoxy group reactive with said carboxyl groups of said intermediate compound for preparing said thermoplastic polymer.

23. A thermoplastic polymer as set forth in claim 22 wherein said epoxy component has at least one internal aromatic group and two terminal epoxy groups.

24. A thermoplastic polymer as set forth in claim 16 comprising a plasticizer comprising an esterification product of a polyoxyalkylene glycol and an aliphatic carboxylic acid.

25. A thermoplastic polymer as set forth in claim 16 comprising fibers selected from at least one of glass fibers, polyamide fibers, cellulose fibers, and ceramic fibers.

26. A thermoplastic polymer as set forth in claim 16 comprising a lubricant being an ester or amide of saturated aliphatic carboxylic acids having from 10 to 40 carbon atoms and saturated aliphatic alcohols or amines having from 2 to 40 carbon atoms.

27. A thermoplastic polymer as set forth in claim 16 comprising a thermal antioxidant having a sterically hindered phenolic group.

28. A thermoplastic polymer as set forth in claim 16 comprising a nucleating agent selected from at least one of talc, kaolin, mica, calcium sulfate, and barium sulfate.

29. A thermoplastic polymer as set forth in claim 16 having a melt flow length of from about 60 to about 80 cm at a temperature of about 260° C. and at a pressure of between about 500 to about 1500 psi according to a spiral flow test method for determining a melt viscosity of the thermoplastic polymer.

30. An article formed in accordance with said thermoplastic polymer set forth in claim 16.

31. A method of preparing a thermoplastic polymer comprising the steps of:
(A) providing a polyalkylene terephthalate and/or polyester thereof having terminal carboxyl groups and hydroxyl groups and internal ester linkages;
(B) reacting a free triglyceride having at least one acid component and at least one epoxy group with at least one of the carboxyl groups of the polyalkylene terephthalate and/or polyester thereof to form an intermediate compound having carboxyl groups; and
(C) reacting a dendrimer having functional groups with the carboxyl groups of the intermediate compound.

32. A method as set forth in claim 31 wherein the dendrimer comprises:
a mono- or polymeric nucleus; and
a plurality of branching units extending from said nucleus;
wherein the branching units terminate with the functional groups.

33. A method as set forth in claim 32 wherein each of the branching units comprise a polyester moiety, a polyether moiety, and combinations thereof.

34. A method as set forth in claim 33 wherein the functional groups are hydroxyl groups and the dendrimer has 6 to 64 hydroxyl groups.

35. A method as set forth in claim 33 wherein the dendrimer has a number-average molecular weight of from about 1500 to about 6500.

36. A method as set forth in claim 31 wherein said steps of reacting a free triglyceride having at least one acid component and at least one epoxy group with at least one of the carboxyl groups of the polyalkylene terephthalate and/or polyester thereof to form an intermediate compound having carboxyl groups, and reacting a dendrimer having functional groups with the carboxyl groups of the intermediate compound are conducted at a temperature of between about 150° C. to about 350° C.

37. A method as set forth in claim 31 wherein the free triglyceride is epoxidized linseed oil.

38. A method as set forth in claim 31 further comprising the step of reacting an epoxy component having at least one terminal epoxy group with the carboxyl groups of the intermediate compound.

39. A method as set forth in claim 38 wherein the epoxy component has at least one internal aromatic group and two terminal epoxy groups.

40. A method as set forth in claim 31 further comprising the step of providing a plasticizer comprising an esterification product of a polyoxyalkylene glycol and an aliphatic carboxylic acid.

41. A method as set forth in claim 31 further comprising the step of providing fibers selected from at least one of glass fibers, polyamide fibers, cellulose fibers, and ceramic fibers.

42. A method as set forth in claim 31 further comprising the step of providing a lubricant being an ester or amide of saturated aliphatic carboxylic acids having from 10 to 40 carbon atoms and saturated aliphatic alcohols or amines having from 2 to 40 carbon atoms.

43. A method as set forth in claim 31 further comprising the step of providing a thermal antioxidant having a sterically hindered phenolic group.

44. A method as set forth in claim 31 further comprising the step of providing a nucleating agent selected from at least one of talc, kaolin, mica, calcium sulfate, and barium sulfate.

45. A method as set forth in claim 31 conducted in an apparatus selected from the group of compounders, single-screw extruders, twin-screw extruders, ring extruders, mixers, and reaction vessels.
